(19) United States
(12) Patent Application Publication
(10) Pub. No.: US 2005/0274237 A1
(43) Pub. Date: Dec. 15, 2005

(54) Locking pliers tool with automatic jaw gap adjustment and user-controlled clamping force magnitude

(76) Inventor: John Andrew Winkler, Tucson, AZ (US)

Correspondence Address: JOHN A. WINKLER;PMB #228, 405 E. WETMORE RD. #117, TUCSON, AZ, 85705, US

(21) Appl. No.: 10/866,849

(22) Filed: Jun. 12, 2004

(51) Int. Cl. B25B 7/12

(52) U.S. Cl. 81/367

(57) ABSTRACT

A locking pliers tool which combines a self-locking, frictional brake, gap setting means to set jaw gap size automatically when clamping onto a workpiece, and an over-center linkage clamping means to securely clamp the workpiece in between the opposing tool jaws, and an adjustment means for varying the clamping force to be exerted onto the gripped workpiece.

### FIELD OF THE INVENTION

This invention relates to the field of portable hand tools known as “locking pliers”, which allow jaw gap adjustment of a set of opposable jaws pivotally fastened to one another, and are able to clamp and restrain a workpiece of variable size and geometry without continuous gripping effort from the operator.

### PRIOR ART

The high workpiece clamping force, characteristic of locking pliers, is achieved by the actuation of an over-center linkage mechanism. The over-center linkage is a special design of the classic four-bar linkage found in use around the world. Prior art for a locking pliers design is shown in Figure A. A fixed member L1 is designed in some fashion to be one of the handles of the tool. The member L1 has two pivot points about which the second member L2 and the fourth link member L4 will pivot. The third member of the four-bar linkage is L3 and is typically made integral to the second handle H1 of the tool. Link members L3 and L4 function as the over-center linkage of the tool. Regardless of the ergonomic details of each link in the design, the functioning link portions of each member are the lengths shown with phantom lines in the figure. The included angle between link L3 and link L4 when the tool is not gripped on a workpiece is at some angle preferably more than 90 degrees but certainly less than 180 degrees. The tool aggressively “locks” onto a workpiece when the link members L3 and L4 are rotated relative to each other to cause the included angle between the two links to become more than 180 degrees. Through the use of hardstop features built into the tool, the tool essentially has two linkage positions which are the release position and the clamp position. Figure A shows the locking pliers tool in the release position where the included angle between L3 and L4 is less than 180 degrees. Figure B shows the locking pliers tool in the clamp position where the angle between link members L3 and L4 is more than 180 degrees, preferably about 185 degrees. Through the use of a hardstop HH in the design, the link members would be prohibited from rotating any more than the angle achieved in the clamp position, which is 185 degrees in this example.

As a force diagram of the link members would show, compressive forces acting along links L3 and L4 drive the compressively loaded links against the hardstop feature of the tool because the links have passed through an included angle of 180 degrees. The link members cannot reverse the direction of rotation on their own and so the tool remains locked onto the workpiece held within the tool jaws as the links remain braced against the hardstop feature. When the user grips the tool to close the handles together about a workpiece, the distance between link pivot points P2 and P4 increases as the relative rotation of link members L3 and L4 changes from a release position to a clamp position as discussed. As shown in Figure A, link L2 of the four-bar linkage is integral to the moving jaw of the locking pliers tool. By comparing the orientation of link L2 between Figure A and Figure B, it can be seen that the link L2 rotates about fixed point P1 as the handles are closed together. This rotation closes the gap between the jaws of the tool to cause the tool to clamp onto a workpiece placed between the tool jaws. Ideally, the jaws of the tool first contact the workpiece as link members L3 and L4 have an included angle varying between 170 to almost 180 degrees, depending on the preferred magnitude of the clamping force exerted against the workpiece. The jaws begin to aggressively clamp onto the workpiece as the user further closes the handles after initial workpiece contact, forcing L3 and L4 to rotate to the clamp position and forcing the clamping jaw and link L2, as a link and jaw of unitary construction, to rotate and aggressively clamp the workpiece between the rotatable clamping jaw and the fixed jaw of the tool.

The difficulty with the prior art is that the opening between the tool jaws when in the clamp position must be carefully adjusted to the size of the workpiece being gripped and this adjustment must be done by the user whenever a new workpiece differs in size from the workpiece previously gripped. This adjustment is done by changing the length of the link member L1. In the prior art a thumbscrew protruding from the end of the fixed handle is used to change the length of link member L1 to consequently vary the size of the clamp position gap between the tool jaws. Figure C shows an example of the prior art with the thumbscrew of the tool backed out of the fixed handle causing the link L1 to become elongated and consequently opening the jaw gap between the tool jaws. The prior art has typically taught that the pivot P4 traverses a slot in the fixed handle of the tool so that the pivot travels along the length of the slot as the thumbscrews drives in and out of the fixed handle of the tool. The user can refine the clamping force exerted on the workpiece by further careful adjustment of the thumbscrew to finely adjust the length of link L1. While functional, this is a very labor intensive operation requiring two handed adjustment of the tool and causes difficulty if the user additionally wishes to hold onto the workpiece with a hand while trying to adjust the thumbscrew of the locking pliers tool.

Previous designs of locking pliers tools have typically had some variation of the classic over-center linkage mechanism described above such as the Vise-Grip® design wherein a thumbscrew at the end of a fixed handle adjusts the gap between the opposing jaw faces. The thumbscrew changes the length of link L1 and the clamp position results in an included angle of about 185 degrees between links L3 and L4. This design has proven itself functional for decades but has always had the drawback that any thumbscrew adjustment of the tool requires two hands. This leaves the solo user with no hands available to hold onto a workpiece during thumbscrew adjustment. Attempts to correct this deficiency have lead to single-hand adjustment designs such as those taught in U.S. Pat. No. 4,499,797, U.S. Pat. No. 6,199,458, U.S. Pat. No. 6,279,431, U.S. Pat. No. 6,314,843, U.S. Pat. No. 6,378,404, and U.S. Pat. No. 6,450,070.

### BRIEF SUMMARY OF THE INVENTION

A highly desired design of a locking pliers tool would reset the jaw gap opening to the largest opening achievable every time the user releases a workpiece from the jaws so that the next workpiece to be clamped, large or small, will surely fit within the open jaws if size permits. Further, the highly desired design would also automatically adjust the gap between the jaws to the size of the workpiece as the user closes the hand grip and would apply a repeatable, user-selected clamping force to the workpiece regardless of the size of the workpiece. The invented tool is designed to be one handed in operation, allowing the user to fully open the unclamped jaws to the largest gap available by simply relaxing the hand grip, and to achieve the correct jaw opening setting for the immediate workpiece simply by squeezing the handles together. Once the jaws have contacted the workpiece, a gap setting means integrated into a first jaw of the tool prevents the jaw gap from increasing during the time that the workpiece is gripped. With the jaw separation gap set for the immediate workpiece held between the jaws, an over-center linkage mechanism connected to a second jaw of the tool begins to actuate so as to increase the clamping force exerted on the workpiece. The linkage mechanism magnifies the gripping force of the operator to eventually achieve a clamping force sufficient to clamp about the workpiece as aggressively as the user deems is necessary. The linkage members rotate to over-center locking positions to lock the jaws so that the clamping force is continually exerted on the workpiece without continuous effort from the operator.

### BRIEF DESCRIPTION OF THE DRAWINGS

Figure A Prior Art shows the prior art of a locking pliers tool with the jaws of the tool opened to receive a workpiece. Figure B Prior Art shows the prior art of a locking pliers tool as the jaws of the tool would be closed about a very thin workpiece. Figure C Prior Art shows the prior art of a locking pliers tool as the jaws of the tool would be set to close about a workpiece with a particular thickness.

FIG. 1 shows a plan view of the disclosed invention with the over-center linkage of the tool set to the release position.

FIG. 2 shows a plan view of the disclosed invention with selected components illustrated by dashed outlines or with sections cut away to show other components also packaged in the assembly.

FIG. 3 shows the tool of the invention with the over-center linkage set to a clamp position and with the sizing handle of the tool removed for illustration clarity.

FIG. 4 illustrates the sizing jaw of the tool rotating to make contact with a workpiece and also shows selected components individually.

FIG. 4a shows an enlarged view of the sizing jaw of the tool and shows the relation of the sizing jaw and sizing handle of the tool.

FIGS. 5a and 5b demonstrate the concept of the sizing jaw adjustment.

FIG. 6a illustrates the setting of the reaction pad of the tool against the main body of the tool to perform the sizing function.

FIG. 6b illustrates both the reaction pad and footpad of the tool setting against the main body of the tool to perform the sizing function.

FIG. 7 illustrates the over-center linkage of the tool performing the clamping function of the tool.

FIG. 8 illustrates the adjustment of the over-center linkage of the tool.

FIG. 9 illustrates a release mechanism concept of the tool as the tool is clamped onto a workpiece.

FIG. 10 illustrates a release mechanism concept of the tool performing a release function.

FIG. 11 illustrates an alternate embodiment of the tool with the over-center linkage of the tool in the clamp position.

FIG. 12 illustrates an alternate embodiment of the tool with the over-center linkage of the tool in the release position.

### DETAILED DESCRIPTION OF THE INVENTION

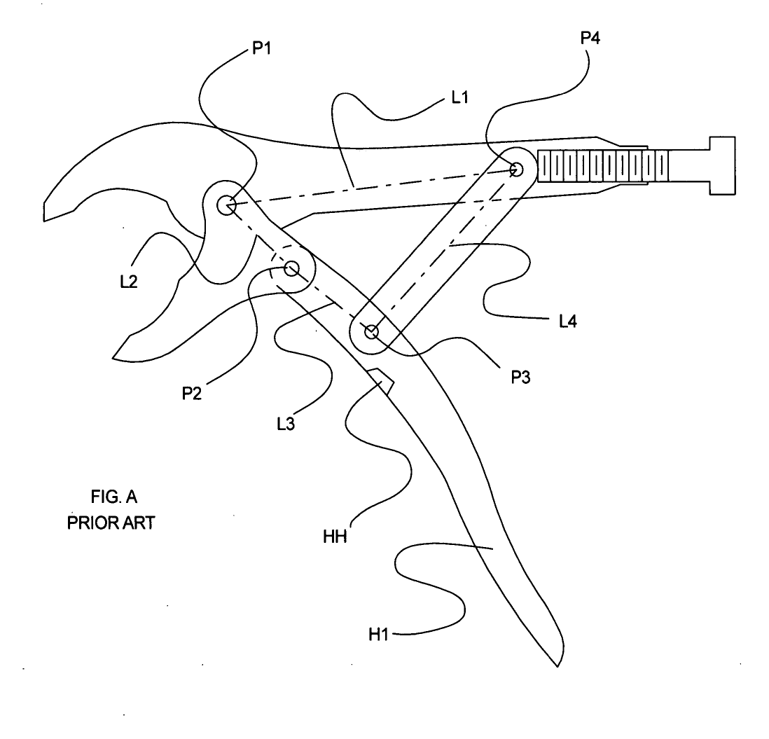

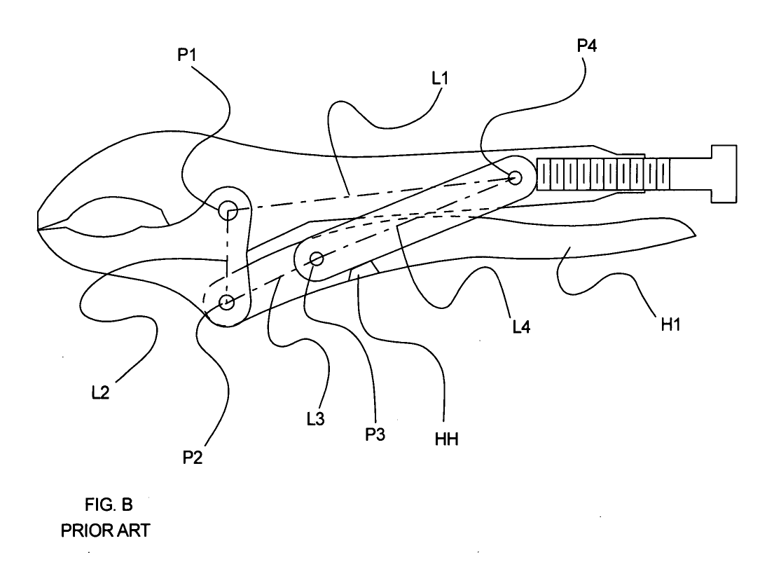

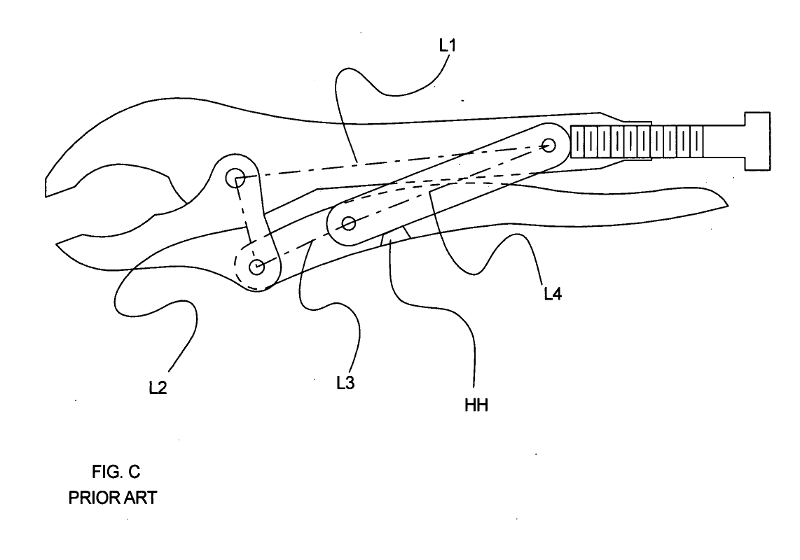

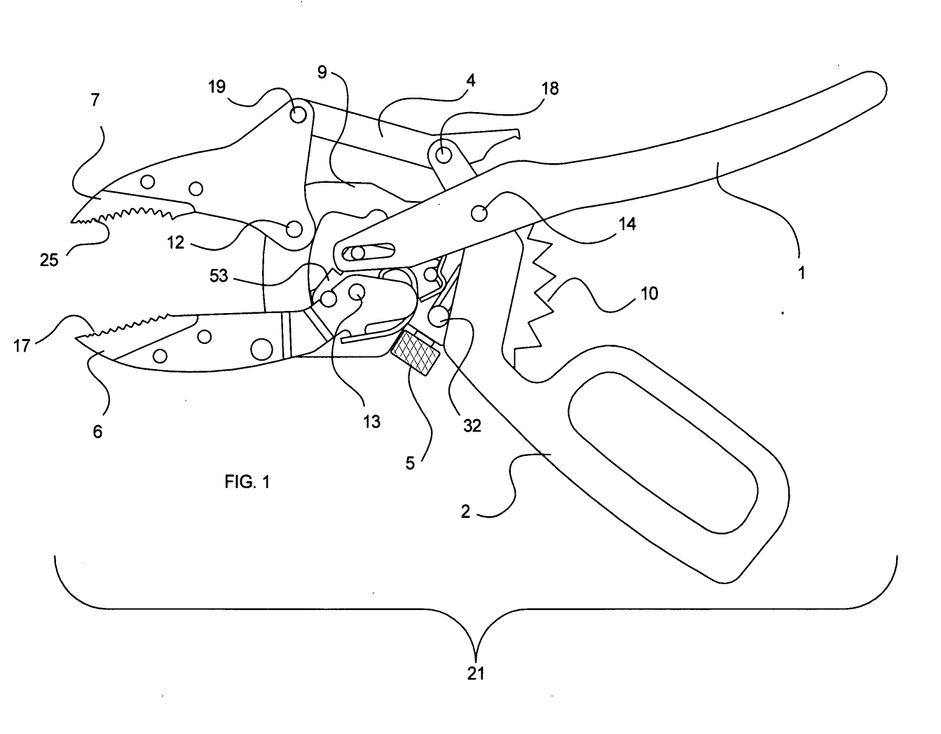

In the figures, similar reference numbers denote similar elements throughout the several views. Shown in FIG. 1 is the disclosed invention, a locking pliers tool 21, able to be held in the hand of an operator. Each jaw performs a separate operation when the jaws come into contact with the workpiece. The jaws move independent of one another as one handle or the other of the tool begins to move because of the gripping action of the operator.

The two handles of the tool are the sizing handle 1, and the clamp handle 2. As they are shown in the figures the handles and various link members of the design are layered piece parts stacked together and pinned as necessary to achieve the design. The base component of the design which the other components mount to is the main body 9. A description of the preferred embodiment is as follows: The sizing handle pins, or is otherwise hingedly connected, to the main body at the sizing handle pivot 14. The clamping jaw 7 pins, or is otherwise hingedly connected, to the main body 9 at the clamp jaw pivot 12. The clamp handle 2 is hingedly connected to the main body at the sizing handle pivot 14. A clamp link 4 hingedly connects to the clamp handle 2 at the over-center pivot 18 and hingedly connects to the clamping jaw 7 at the jaw drive pivot 19 via pins or other hinging means. The clamp handle 2 assembles against the face of the main body 9 via the pin at the sizing handle pivot 14, and the sizing handle 1 assembles against the face of the clamp handle 2 on the same pin at the pivot 14. The sizing jaw 6 pins, or is otherwise hingedly connected, to the pivot arm 53 at the sizing jaw pivot 13. The jaw gap is the distance between the workpiece faces 17 and 25.

A sizing handle spring 10 is incorporated to push against the sizing handle 1 and the clamp handle 2 thereby encouraging the clamp handle 2 to rotate away from the sizing handle. The handles rotate relative to the main body as well. For descriptive purposes, the clamp handle release position, also described as the release position, is the orientation of the clamp handle relative to the main body wherein the tip of the clamp handle is the farthest linear distance from the tip of the sizing handle and the pin at the over-center pivot 18 is farthest away from the outlining profile of the main body.

In FIG. 2 the sizing handle 1 has been shown as a dashed outline and some components have been cut away for illustration clarity. Shown in FIG. 2, a clamp handle spring 26 is also connected between the clamp handle 2 and the main body 9 to further urge the clamp handle to rotate away from the sizing handle and remain at the release position. By engineering design the clamp handle spring is primarily used to drive the clamp handle to the release position to keep the clamping jaw retracted away from the sizing jaw. When a workpiece is not clamped between the jaws of the tool and the hand grip of the user has been relaxed, the sizing handle spring 10 and the clamping handle spring 26 urge the handles to open to their farthest positions away from each other. This also has the effect of urging the jaws of the tool, shown as items 6 and 7, to open up to achieve the largest gap possible between the jaw faces 17 and 25. A hardstop pin 32 is located in a pin adjustment slot 52 that has been cut in the main body 9. An adjustment screw 23 is used to threadedly attach the hardstop pin to the main body. The adjustment screw 23 is rotated when the operator turns the adjustment thumbwheel 5. The rotation of the screw causes the hardstop pin 32 to translate within the adjustment slot 52 to vary the location of the pin 32 within the slot 52. The profile of the clamp handle 2 comes into contact with the hardstop pin 32 when the handle is rotated to the release position. Changing the position of the adjustment pin in the adjustment slot changes the contact point where the clamp handle surface profile comes to rest against the hardstop pin at the release position. Consequently, the contact point between the pin 32 and the handle 2 determines the orientation, relative to the main body, of the clamp handle release position. This will be explained in greater detail later.

The four components consisting of the main body 9, the clamp handle 2, the clamp link 4, and the clamping jaw 7 comprise a four-bar linkage system. The clamp handle connects to the clamping jaw through the clamp link. Via the clamp link 4, the clamp handle orientation relative to the main body controls the orientation of the clamping jaw relative to the main body. By moving the clamp handle 2 relative to the main body, the user changes the clamping jaw orientation relative to the main body.

The section of the clamp handle between the over-center pivot 18 and the pivot 14 is part of an over-center linkage used to lock down the jaws onto a workpiece placed between the jaws. In the clamp handle release position the clamping jaw workpiece face 25 is retracted away from the sizing jaw workpiece face 17, and the over-center pivot 18 is distanced from the profile of the main body 9 as far as the adjusted setting of the hardstop pin 32 will allow.

In FIG. 3 the sizing handle has been removed for illustration clarity along with some other components. FIG. 3 shows the clamp handle 2 after the handle has been rotated to the clamp position. The clamp position is defined as the clamp handle orientation relative to the main body wherein the profile of the clamp link 4 contacts and rests on the profile of the main body 9 at the over-center pivot 18. In the clamp position the clamping jaw 7 has been rotated relative to the main body to decrease the jaw gap distance between the clamping jaw face 25 and the sizing jaw face 17 compared to the gap distance between the faces at the clamping handle release position. The decrease in gap distance as the clamping jaw rotates is the event which dramatically increases the clamping force that the jaws exert against a workpiece held between them at the workpiece faces 17 and 25. The gap distance must be appropriately sized to the workpiece for the clamping jaw rotation to successfully increase the clamping force. Adjusting the size of the the jaw gap is performed by moving the sizing jaw 6 relative to the main body 9.

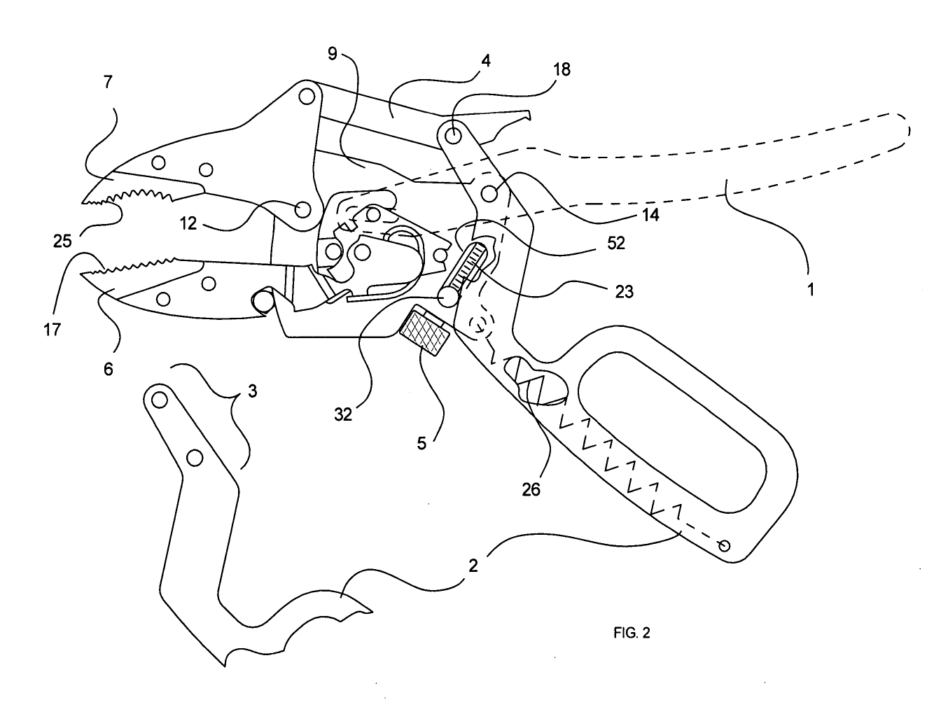

In FIG. 4 some components have been cutaway or illustrated using hidden lines for illustration clarity. FIG. 4 shows the pivot arm 53 which is the coupling means that couples the sizing jaw 6 to the sizing handle 1, as well as to the main body 9, and allows rotation of the sizing jaw relative to the main body. The sizing jaw pins, or is otherwise hingedly connected, to the pivot arm at the sizing jaw pivot 13. The pivot arm 53 is operably coupled to the main body by a pivot arm slot 28 which couples to a pin in the main body 9 at the pivot arm pivot 8. The pivot arm slot 28 in the pivot arm 53 allows a small amount of translation of the pivot arm relative to the main body but the pivot arm primarily has a rotational degree of freedom relative to the main body.

Rotation of the pivot arm is controlled by the pin and slot interaction at the sizing handle to pivot arm slide 11, shown in FIG. 4a. In FIG. 4a some components have been cutaway or illustrated using hidden lines for illustration clarity. The pivot arm rotates through approximately 40 degrees depending on the preferred gap opening that can be achieved between the jaws. The slide 11 reduces the amount of rotational displacement required of the sizing handle 1 to effect the approximately 40 degrees of rotation of both the sizing jaw 6 and the pivot arm. The pin and slot interaction of the slide 11 also allows for the small amount of translation of the arm 53 relative to the main body 9. The process to clamp onto a workpiece happens in essentially two steps: sizing for the workpiece, which is performed by rotation of the sizing jaw, and exerting a large, continuous clamping force against the workpiece, which is performed by rotation of the clamping jaw.

Referring to FIGS. 4 and 4a, the workpiece sizing process begins as follows: The clamp handle spring 26 always urges the clamping jaw and clamp handle to the release position when the jaws are opened. With the user resting the clamping jaw workpiece face 25 of the retracted clamping jaw on the workpiece 30 to be clamped, the user begins to close the hand grip. The user's grip causes sizing handle 1 to rotate relative to the main body 9. The sizing handle spring 10 opposes the motion but has less force than the clamp handle spring 26, so the sizing handle, not the clamp handle, moves first. The rotation of the sizing handle initiates rotation of the pivot arm 53 relative to the main body because of the pin and slot interaction at the slide 11. The rotation of the pivot arm relative to the main body causes the sizing jaw hinged to the pivot arm to travel towards the clamping jaw 7. The travel of the sizing jaw closes the gap between the jaws until the sizing jaw workpiece face 17 comes into contact with the workpiece 30 and the jaw gap between the faces 17 and 25 cannot be closed any further due to opposition by the workpiece.

Continued operator gripping causes the wedging footpad 15 of the sizing jaw and the wedge reaction pad 22 to frictionally clamp about the rib 27 of the main body 9 to set the sizing jaw position relative to the main body. The frictional clamping about the rib 27 is effected by a frictional brake process.

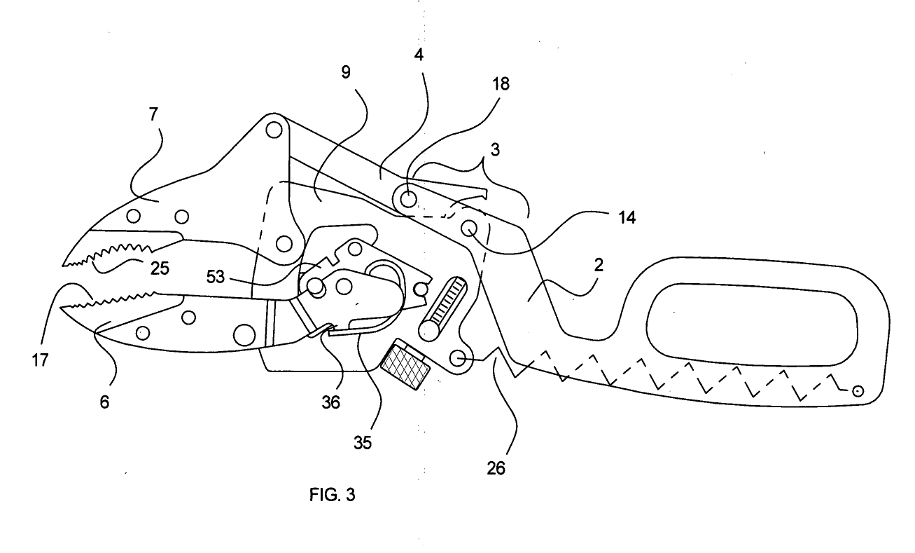

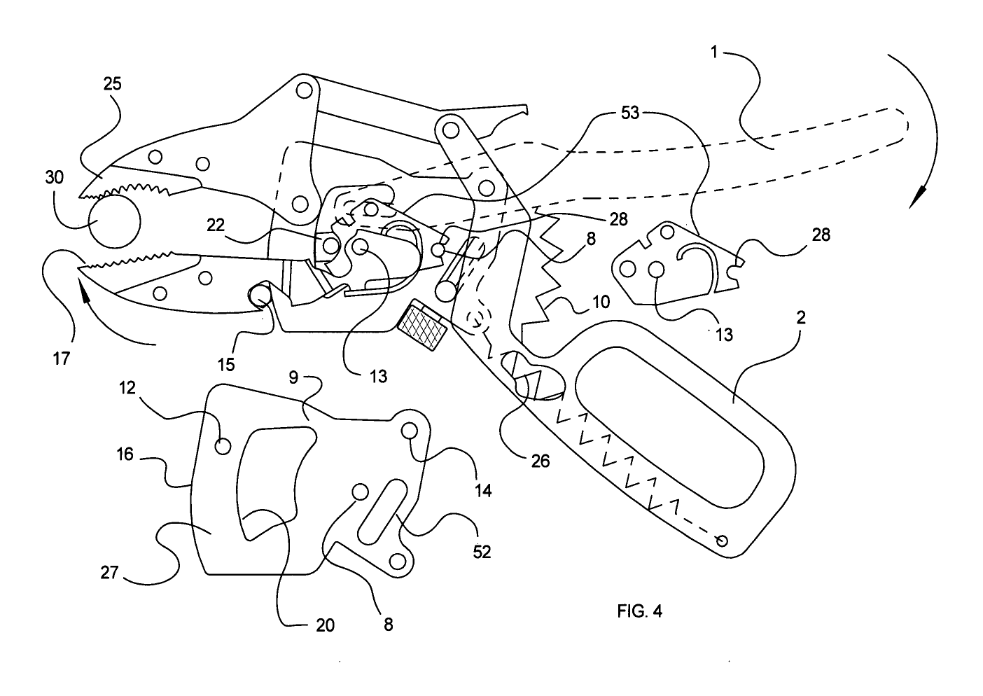

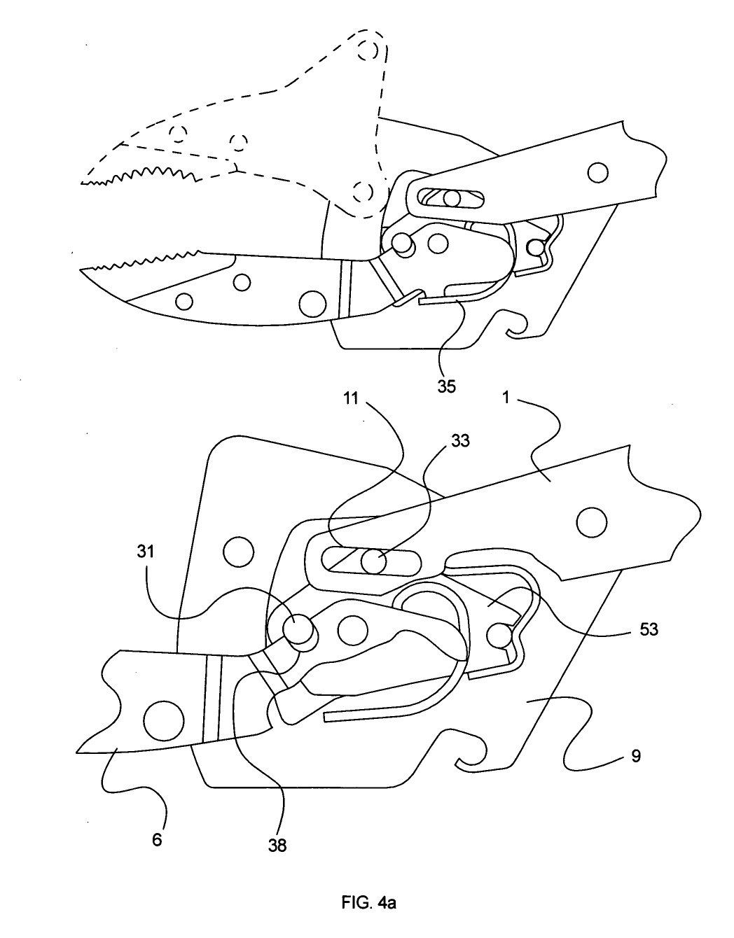

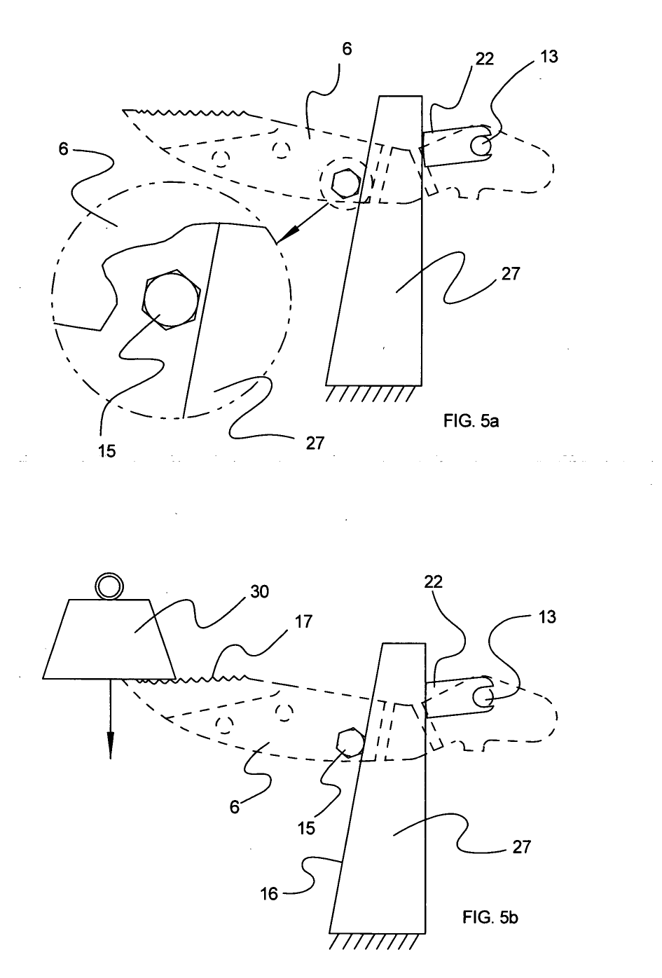

The clamp down and wedging action that effects the friction brake about the main body rib 27 is exaggerated in FIGS. 5a and 5b. FIG. 5a shows a wedge shaped rib 27 which is in a fixed location and, for concept description, the sizing jaw pivot 13 is also in a fixed vertical location, but not horizontal location. Relative to the fixed ground, the sizing jaw 6, shown as a dashed outline, can rotate about the pivot 13, and can translate with the pivot 13 as the pivot translates horizontally. Initially, the wedging footpad 15 of the sizing jaw 6 and the wedge reaction pad 22, which mounts securely to the pivot arm (not shown), are not in contact with the rib.

In FIG. 5b a workpiece 30 has made contact with the sizing jaw workpiece face 17 and is exerting a force against the face 17 to drive the sizing jaw towards the base of the rib 27. The sizing jaw pivot 13 is fixed vertically and opposes the vertical travel of the arm towards the base of the rib. The workpiece force causes a torque moment about the jaw pivot 13 thereby initiating rotation of the sizing jaw 6 at the jaw pivot until the footpad 15 makes contact with the outer brake surface 16 of the rib 27. The instantaneous location where the footpad 15 contacts the outer brake surface 16 of the rib serves as a new pivot point for the torque moment created by the force from the workpiece. Under the force from the workpiece, the sizing jaw continues to rotate about the footpad 15 instantaneous pivot, horizontally translating the sizing jaw pivot, and the wedge reaction pad attached to it, until the wedge reaction pad 22 makes hard contact with the surface of the rib opposite the outer brake surface 16. The wedge footpad 15 and the wedge reaction pad 22 clamp about the rib 27 to create a frictional brake to fix the position of the sizing jaw relative to fixed ground.

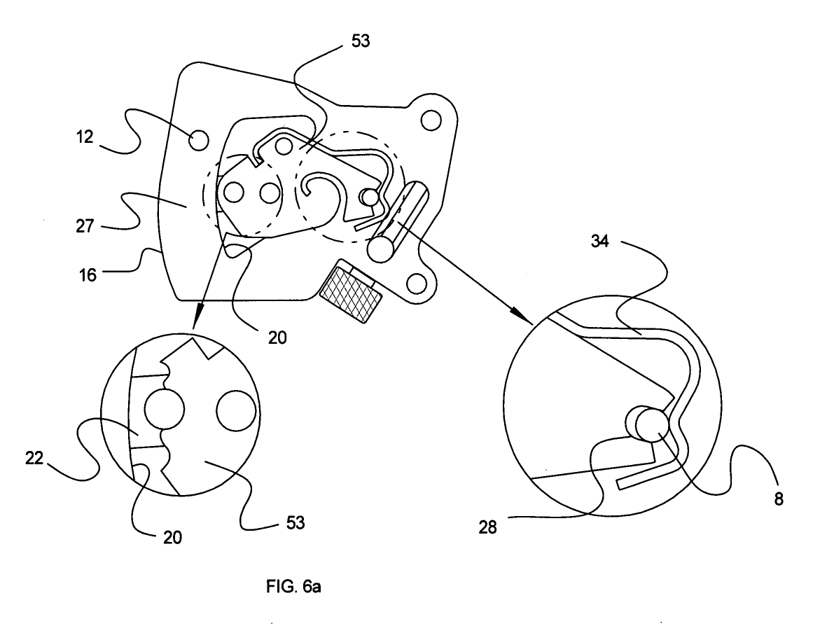

Though a force from the workpiece is trying to push the sizing jaw 6 towards the base of the rib, the clamping action of the footpad 15 and reaction pad 22 have prevented the movement of the jaw. Movement of the sizing jaw is prevented by the mechanical interference of the wedge-shaped rib 27 being clamped, and frictionally held, between the footpad 15 and reaction pad 22. The force of the workpiece 30 pressing against the workpiece face 17 only enhances the frictional clamping effect of the footpad. As the workpiece 30 presses against the face 17 with greater force, the footpad and reaction pad clamp onto the mechanically interfering rib with proportionally greater force to maintain the position on the rib at the instantaneous location. This footpad and reaction pad clamping action against the rib thereby temporarily fixes the location of the jaw 6 relative to the rib 27 and consequently, the workpiece 30 is then held at a fixed position relative to the rib. Removal of the force exerted by the workpiece 30 against the sizing jaw 6 will remove the frictional clamping effect of the footpad 15 and reaction pad 22 to once again permit travel of the wedge reaction pad 22 and sizing jaw 6. A similar wedge shaped rib has been built into the main body and is shown as item 27 in FIG. 6a. Sections of some components in FIG. 6a have been cut away for illustrative clarity.

While it is possible to manufacture the wedge shaped rib separately from the main body and assemble the rib onto the main body, the preferred embodiment of the tool has the wedge shaped rib and the main body manufactured as a single component of unitary construction. The wedge shaped rib 27 has the smallest cross section near the clamping jaw pivot 12. The wedge of the rib dimensionally increases in cross-sectional thickness so that the thickest rib cross section occurs through the rib geometry located farthest away from the pivot 12. Similar to the description of FIG. 5a, the wedge reaction pad 22 of FIG. 6a is securely mounted to the pivot arm 53. The reaction pad 22 and pivot arm 53 displace together by rotation and translation allowed by the pivot arm slot 28 coupled to the pivot arm pin 8 and the slide 11 of the sizing handle 1, seen in FIG. 4a. Also shown in FIG. 6a is the pivot arm return spring 34 which urges the pivot arm to a position such that the pivot arm pin 8 is deep in the pivot arm slot 28. In this return position the wedge reaction pad 22 is not in contact with the inner brake surface 20 of the rib of the main tool body and the pivot arm can rotate freely as urged by the sizing handle.

Referring now to FIG. 6b with a review of the sizing action, when the user holding the tool begins a constricting hand grip to close the handles, the hand grip portion of the sizing handle rotates toward the clamp handle. The constricting operator hand grip is actuating the sizing handle and reducing the jaw gap while the clamp handle spring urges the clamp handle and clamping jaw to remain stationary relative to the main body. The rotary motion of the sizing handle relative to the main body causes the cutout slide 11 of the sizing handle to exert a tangential force against the sizing handle slide pin 33. The sizing handle slide pin operably couples the sizing handle 1 to the pivot arm 53. The tangential force at the pin 33 rotates the pivot arm 53 towards the clamping jaw pivot 12. The rotation of the pivot arm relative to the main body brings the sizing jaw 6 closer to the clamping jaw 7, thereby closing the jaws to adjust the jaw gap appropriately for the size of the workpiece.

A wedging footpad 15 is manufactured as part of the sizing jaw mechanism. The footpad is lifted off of the outer brake surface 16 of the main body 9 by a sizing jaw control spring 35. This spring is anchored in the pivot arm 53 and keeps the wedging footpad 15 from inadvertently engaging the outer brake surface 16 as the sizing jaw 6 rotates relative to the main body to contact the workpiece or reset to the largest gap opening. The control spring 35 urges the sizing jaw 6 to a position relative to the pivot arm 53 where a cutout notch 38, seen in FIG. 4a, of the sizing jaw contacts the profile of the wedge reaction pin 31 protruding from the pivot arm 53. The control spring 35 and cutout notch urge the sizing jaw 6 up against the pin 31 so that the jaw and pivot arm move simultaneously whenever the sizing jaw is not in contact with a workpiece and the pivot arm is actuated.

The frictional engagement brake effect of the sizing jaw against the rib 27 initiates when the sizing jaw workpiece face 17 has come into contact with the workpiece 30 placed between the clamp jaw 7 and the sizing jaw 6. After the sizing jaw contacts the workpiece and the operator continues a constricting grip, the force of the operator's grip is resisted by the workpiece.

The operator grip is trying to rotate the sizing jaw toward the clamping jaw via the pivot arm and the workpiece exerts a reactionary force to oppose the movement. This force couple rotates the sizing jaw about the sizing jaw pivot 13 to bring the footpad 15 into contact with the outer brake surface 16. An instantaneous pivot develops where the footpad 15 contacts the outer brake surface 16. This becomes the new location of rotation for the torque moment caused by the workpiece and pivot arm force couple.

The continued rotation of the sizing jaw about the footpad 15 cause the pivot arm 53 to displace as permitted by the pivot arm slot 28 and slide 11 until the wedge reaction pad 22 contacts the inner brake surface 20 of the main body 9. The inner brake surface 20 of the main body is approximately concentrically located to the pivot arm pivot 8 and offers a frictional contact surface of the rib 27 for the wedge reaction pad 22 to press against. The reaction pad has a curved contact surface shaped to match the curvature of the inner brake surface 20 so that the inner brake surface 20 and the reaction pad 22 have a curved conforming geometry to achieve an intimate contact. When the footpad 15 and the wedge reaction pad 22 have both contacted the opposite facing brake surfaces of the rib, the frictional engagement brake is effected and the wedge shaped rib 27 becomes clamped between the footpad and the reaction pad. The sizing jaw 6 cannot retreat away from the clamping jaw 7 because the wedge shaped rib is thicker in cross section below the footpad contact point and the reaction forces at the jaw pivot 13 and footpad 15 are preventing the footpad and wedge reaction pin from separating away from each other. The wedge shaped cross-section of the rib causes a mechanical interference to prevent the footpad and reaction pad, clamped about the rib, from slipping down the rib and away from the clamping jaw pivot 12. The mechanical clamping of the wedge shaped rib between the footpad and reaction pad ensures that the sizing jaw will remain temporarily fixed relative to the main body and thus the jaw gap will be properly sized for the workpiece while the workpiece is being held between the jaws.

It is well understood in the art of the vehicular braking industry that an effective frictional engagement brake will have a hardened material in intimate contact with a softer material to prevent relative motion between the two materials. A much higher friction coefficient is developed between a well chosen hard material and soft material than the friction coefficient that develops between two materials of approximately the same hardness in intimate contact. To achieve a high frictional coefficient between the main body rib 27, and both the wedge footpad 15 and wedge reaction pad 22, the rib has been plated with a soft material known in the art, such as copper or a copper-based alloy metal plating, preferably less than 0.004 inches thick, but preferably not more than 0.010 inches thick. This plating thickness of copper provides a soft material for the hardened footpad 15 and reaction pad 22 to intimately contact to develop high frictional forces for achieving a suitable frictional engagement brake effect about the rib. When compressed by the footpad and reaction pad, the plating less than 0.004 inches thick will not remain permanently deformed to a significant state that would affect long term operation of the tool, so it is preferred. Plating thicker than 0.010 inches would likely shear within the thickness of the plating material, and separate away from the brake surfaces of the rib under the high reaction force loads of the frictional brake mechanism.

The clamping force on the held workpiece dramatically increases from a light contact to a compressive force possibly in excess of 1000 pounds as the constricting hand grip of the user brings the clamp handle from the release position to the clamp position. As described previously, rotating the clamp handle from the release position to the clamp position drives the clamping jaw workpiece face 25 toward the temporarily fixed sizing jaw workpiece face 17. The high clamping force developed between the workpiece faces 25 and 17 positively secures the workpiece between the jaws for operator manipulation of the workpiece.

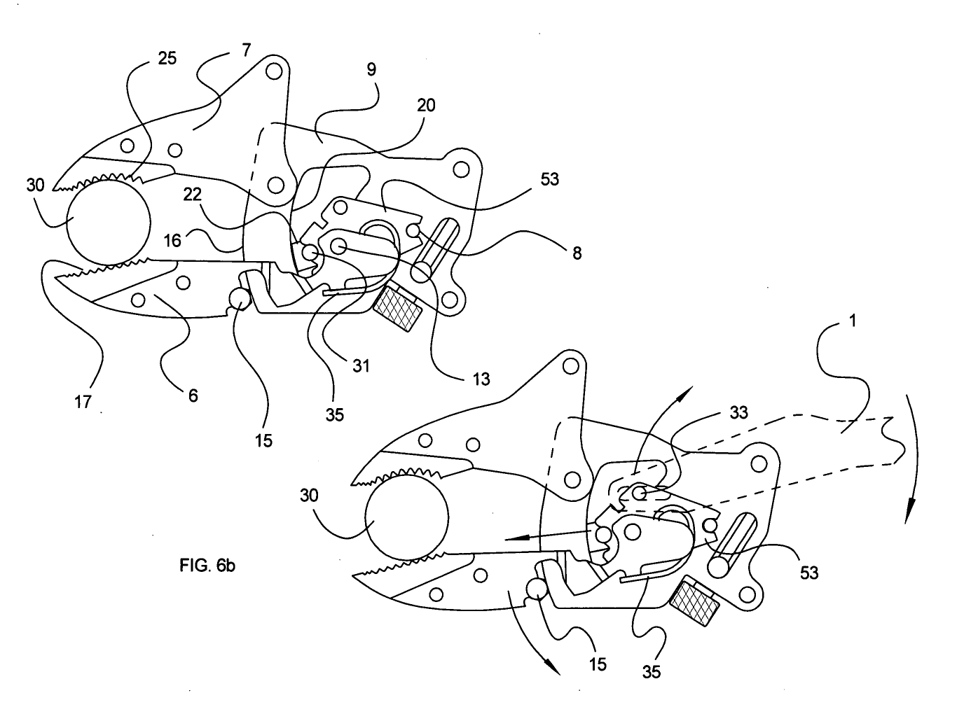

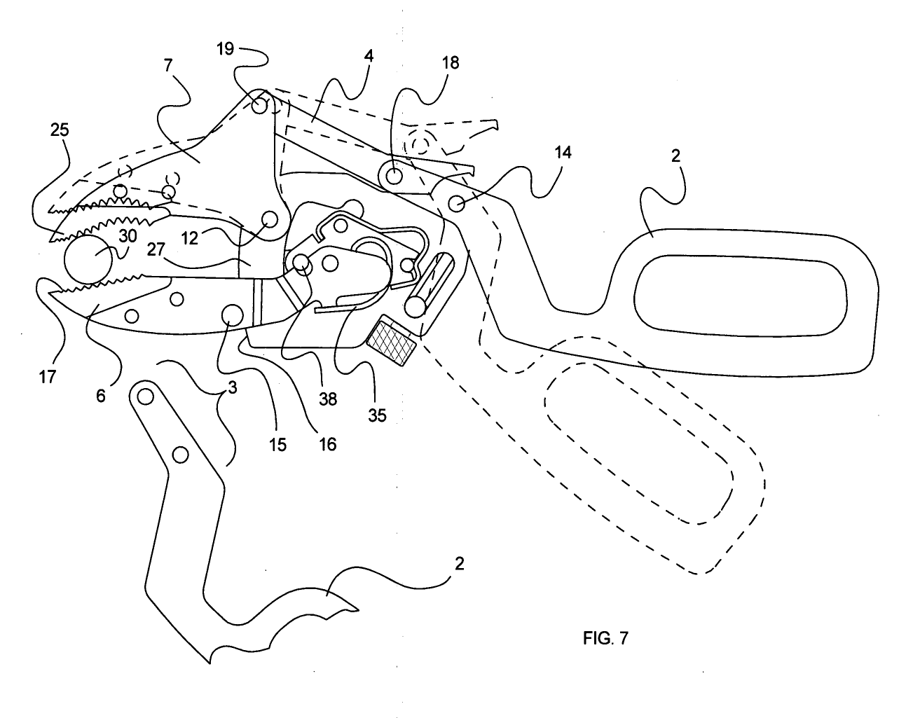

The clamp handle spring 26 will urge the clamp handle to remain at the release position while the necessary sizing process of the sizing jaw is taking place. With the sizing process complete and the sizing jaw frictionally fixed relative to the main body, the continued operator grip causes the clamp handle to begin to rotate from the release position to the clamp position. The action of rotating the clamp handle relative to the main body drives the clamp link 4 towards the jaw drive pivot 19 as shown in FIG. 7. The clamp handle and clamp link starting position is shown in FIG. 7 by a starting position dashed outline of the clamp handle 2 and clamp link 4. The finished clamped position is shown as solid outlines of the same components. The compressive force that the clamp link 4 exerts on the jaw drive pivot 19 creates a torque about the clamping jaw pivot 12 which causes the clamping jaw 7 to rotate, thereby driving the clamping jaw workpiece face 25 towards the temporarily fixed jaw face 17 of the sizing jaw 6. The workpiece, held between the jaws and assumed to be of a stiff material, is exerting a reaction force against both jaw faces 17 and 25. The operator's increasingly stronger constricting grip increases the magnitude of the force acting on the clamp handle. A proportionately increased compressive force applied through the clamp link acts on the clamping jaw 7 to rotate the workpiece face 25 towards the fixed jaw face 17, resulting in a proportionately increased clamping force being exerted by the jaw 7 against the workpiece.

The large clamping force which can be exerted by the tool against a workpiece must also be reacted by the components of the design. Components made of soft materials such as copper or even aluminum will plastically deform under the stresses related to large forces and are not suitable materials for the design of the major components of a clamping tool. For longevity, the tool material should be a hardenable material with some ductility such as a hardenable steel known in the art, of which there are several such as AISI 4130. The steel alloy used for the main body 9, pivot arm 53, wedge reaction pad 22, wedge footpad 15, sizing jaw 6, clamping jaw 7, clamp link 4, and clamp handle 2 tool components should be processed to a minimum hardness of 42 on the Rockwell C hardness scale. Preferably the components would be hardened to approximately 54 on the Rockwell C hardness scale to prevent permanent deformation induced by high force loads from tool useage.

Though the material used to make the invention is intended to be quite stiff and of high strength, preferably hardenable steel, there will still be some very small deflection of the jaw components 6 and 7, as well as the main body 9, and the link members which make up the invention. Similarly, there will be a very small deflection of the stiff workpiece as well. The small deflection of these components is a real parameter of any locking pliers tool known in the art and the disclosed tool is no different. With adequate force provided from the grip of the operator, the clamping jaw 7, though opposed by the stiff workpiece, can be rotated toward the sizing jaw 6 until the jaw drive pivot 19, the over-center joint 18, and the sizing handle pivot 14 are colinear. The colinear alignment of these hinge pivots maximizes the linear distance between the pivot 19 and the pivot 14 to maximize the travel of the jaw workpiece face 25 towards the jaw workpiece face 17 and maximize the force that the jaws exert against the workpiece. For descriptive purposes, the orientation of the clamp handle and clamp link wherein the pivots 19, 18 and 14 are colinear is known as the hinge colinearity orientation. The link portion between the pivots 14 and 18 is the first part of an over-center linkage and will also be described as the actuating arm 3. In the preferred design the actuating arm 3 is integrally manufactured as part of the clamp handle 2 as a single component of unitary construction. The portion of the clamp link 4 between the pivots 18 and 19 is the second part of the over-center linkage. The first end of the clamp link 4 is hingedly connected to the first end of the actuating arm 3 at the over-center joint 18. The other end of the clamp link is hingedly connected to the clamp jaw at the clamp jaw pivot 19. The second end of the actuating arm is hingedly connected to the main tool body 9 at the sizing jaw pivot 14. The angle between the linkage members at the hinge colinearity orientation is 180 degrees if the over-center pivot 18 is used as the vertex of the measured angle.

By design, the clamp handle can continue to rotate past the hinge colinearity orientation and proceed to rotate to an angular position where the angle between the over-center linkage members is about 176 degrees, or about four degrees beyond colinearity. The actuating arm 3 and clamp link will rotate past colinearity until the profile surface of the clamp link 4 is in hard contact against the profile of the main body 9 as shown in FIG. 3. The hard contact of the clamp link 4 against the main body 9 prevents further relative rotation of the clamp handle thus, at this orientation, the clamp handle has been fully rotated to the clamp position. It is possible that the tool could be designed such that the over-center linkage members are rotated to an orientation of about 15 degrees beyond colinearity at the clamp position, but in the preferred design the over-center linkage rotates to about four degrees beyond colinearity to maximize the clamping force exerted on the workpiece when the pliers are “locked” in the clamp position. Every time the locking pliers tool is clamped onto a workpiece, the clamp position of the clamp handle 2 is approximately at the same orientation relative to the main body at about four degrees beyond the hinge colinearity orientation of the over-center linkage. This orientation is due to the clamp link being firmly seated against the profile of the main body

A force diagram would show that at the clamp position, the force acting between the clamping jaw and workpiece must be equally opposed at the jaw drive pivot 19 by the clamp link 4 connected to the clamping jaw. The compressive force which is developed in the clamp link acts along the clamp link between the pivots 19 and 18 and is reacted by the actuating arm 3 portion of the clamp handle 2 and the main body at the over-center pivot 18. The clamp link reaction in the clamp handle loads the actuating arm portion of the handle in compression. Because of the small, approximately four degree angle between the clamp link and clamp handle at the pivot 18, a force is exerted against the main body by the clamp link at the point where the clamp link is in contact with the main body. It is a matter of safety to understand that the compressive force acting along the clamp link may undesirably reverse the rotation of the clamp handle and drive the clamp handle back to the release position at a high rate of speed if the handle is only rotated to the hinge colinearity orientation. An angle of approximately four degrees beyond the colinear orientation, or approximately four degrees over-center, is adequate to ensure that the component of the clamp link compressive force which drives the clamp link against the main body profile is of significant magnitude to firmly seat the clamp link against the main body. Firm seating against the main body profile will prevent undesired, unexpected spring back of the clamp handle, and thus “lock” the pliers in a clamping state. In the locked position of the over-center mechanism at approximate four degrees over-center, the clamp link can continuously exert, without operator effort, a compressive force against the jaw drive pivot to restrain the held workpiece with a high clamping force.

When the operator has finished work on the workpiece item that has been clamped between the jaws, the operator spreads apart the handles 1 and 2 to release the workpiece. Initially the sizing handle 1 will not move relative to the main body 9 because the intact frictional brake of the sizing jaw 6 will prohibit movement of the pivot arm 53 which is coupled to the sizing handle at the slide 11. Instead, spreading apart, or opening up, the handles will begin to rotate the clamp handle 2 from the clamp position back to the release position. As the clamp handle rotates from the clamp position and continues past the hinge colinearity orientation, the compressive force from the clamp link which acts at the over-center pivot 18 begins to develop a component which drives the over-center pivot farther away from the main body profile. Once rotated past the hinge colinearity orientation, the large compressive force along the clamp link positively drives the clamp handle completely to the release position. The clamp handle spring 26 helps to urge the clamp handle to the release position.

With the clamp handle at the release position the clamping jaw is exerting very little compressive force against the workpiece at the workpiece face 25. Thus, the compressive force between the workpiece and the sizing jaw workpiece face 17 is likewise diminished. The pivot arm return spring 34, which is most clearly shown in FIG. 7 and FIG. 6a, displaces the pivot arm, and the wedge reaction pad 22 secured to the arm, away from the inner brake surface 20 of the rib 27. The return spring retracts the pivot arm to the position where the pivot arm pin 8 is deep within the pivot arm slot 28. With no significant sizing jaw force acting about the sizing jaw pivot 13 to effect the frictional brake, the sizing handle spring 10 urges the sizing handle to its orientation where the tip of the handle 1 is linearly at the farthest distance from the tip of the clamp handle 2. Due to the slider joint coupling of the sizing handle and pivot arm at the slide 11, this reset orientation of the sizing handle returns the sizing jaw 6 to the largest gap position where the jaw gap between the workpiece faces 25 and 17 is as large as possible. The wedging footpad 15 of the sizing jaw is lifted away from the outer brake surface 16 by the control spring 35 during this reset operation. With the clamp handle reset to the release position, and the sizing jaw reset to the largest jaw gap position, the operator can manipulate the tool in order to clamp onto another workpiece of any size and geometry that will fit in between the gap of the workpiece faces 17 and 25.

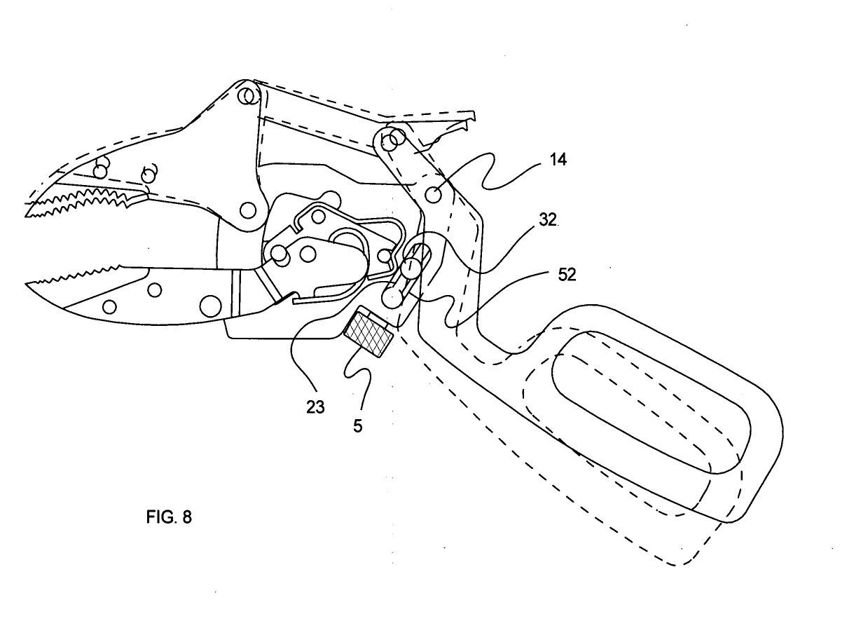

Referring now to FIG. 8, if the operator wishes to clamp onto the next workpiece with a greater or lesser clamping force than previously used, the operator uses the adjustment thumbwheel 5 to adjust the clamping force that will be exerted on the workpiece. By turning the adjustment thumbwheel 5 the operator translates the hardstop pin 32 along the adjustment screw 23 to change the clamp handle release position. If the hardstop pin 32 is translated to the end of the pin adjustment slot 52 that is closest to the pivot 14, the rotation of the clamp handle will be small from the clamp position to the release position as compared to the handle rotation if the hardstop pin were at the opposite end of the adjustment slot. The amount of angular rotation of the clamp handle from the release position to the clamp position affects the angular rotation of the clamping jaw 7 relative to the main body 9. The amount of clamping jaw rotation from a release position to the clamp position directly affects the magnitude of the clamping force exerted on the workpiece.

The closer the hardstop pin 32 is moved to the pivot 14, the smaller the angular travel is from the clamp handle release position, where the clamp handle profile contacts the hardstop pin, to the clamp position. If the hardstop pin 32 is at the slot end closest to the pin 14, the clamp link and the clamp handle over-center section are very near the hinge colinearity orientation and the clamping jaw will not rotate significantly as the clamp handle rotates from the release position, through the hinge colinearity orientation, to the clamp position. When the clamp handle rotation is small, the clamping jaw rotation is small and relatively less proportional force is developed against the workpiece being held. This “light clamp force” setting is depicted using solid lines in FIG. 8.

Alternatively, if the hardstop pin 32 is set at the opposite end of the slot 52 so that it is farthest from the pivot 14, there will be a larger rotation from the clamp handle release position to the clamp handle clamp position. This setting is depicted as dashed lines in FIG. 8. At this extreme hardstop pin setting, the clamp link and over-center section of the clamp handle have an included angle of approximately 140 degrees. This is significant relative to the 180 degree included angle at the hinge colinearity orientation. There will be a large rotation of the clamping jaw as the clamp handle and clamp link rotate to the clamp position from this release position of the clamp handle. The large clamping jaw rotation results in a significant force, possibly in excess of 1000 pounds, being developed against the workpiece due to the large displacement of the clamping jaw workpiece face 25 rotating from a release position orientation to a clamp position orientation. Through the adjustment of the hardstop pin 32 a linkage angle setting means controls the maximum relative rotational position between the main tool body and the clamp handle. This permits the user to select the magnitude of the clamping force exerted against the workpiece regardless of the size of the workpiece.

The mechanical advantage of an over-center linkage mechanism enables the user to develop a workpiece-constraining clamping force between the jaws without continued grip exertion from the operator. As long as the clamp handle is oriented to the clamp position, the over-center linkage is in the “locked” position and the clamping force acting on the workpiece will be continually exerted. A large clamping force, when selected, is useful to ensure tool slippage does not occur for operations such as torquing of a shaft, or aggressive workpiece manipulation tasks, where strenuous physical exertion is put forth by the user and workpiece slippage within the jaws could be dangerous. A light clamping force is useful for operations such as quick clamping of bonded delicate workpiece materials. It is also possible to simply use the tool as a standard pair of pliers by setting the hardstop pin to a suitably high clamping force and simply gripping onto a workpiece without rotating the clamp handle past the hinge colinearity position. Without going past the colinearity position, the clamp handle will be urged by the clamp handle spring 26 back to the release position if the operator relaxes the hand grip. This mode of operation could be useful for quick tasks such as fencing wire manipulation or quick fastening of a nut onto a bolt.

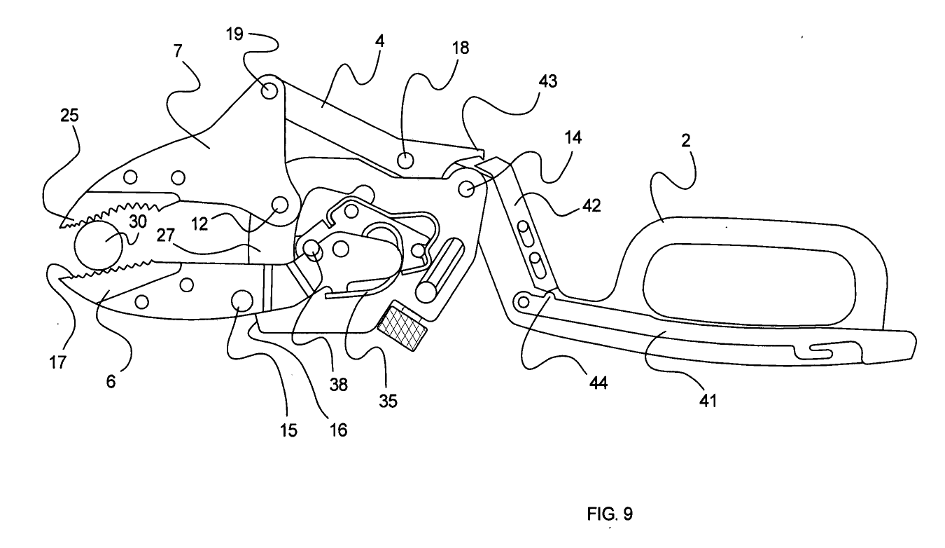

In FIG. 9 a release lever 41 adapted to urge the clamp handle to the clamp handle release position and a release slide 42 have been integrated into the tool as an alternate embodiment. In the figure some components have been removed for illustrative clarity. As shown, the clamp handle 2 pins or otherwise hingedly attaches to the side of the main tool body 9 and to the over-center pivot 18 of the clamp link 4. The release lever 41 and release slide 42 pin or otherwise attach to the side of the clamp handle so as to be inline with the main body and clamp link. In the clamp handle clamp position, the release slide is situated between a cam 44 on the release lever and an extension 43 of the clamp link.

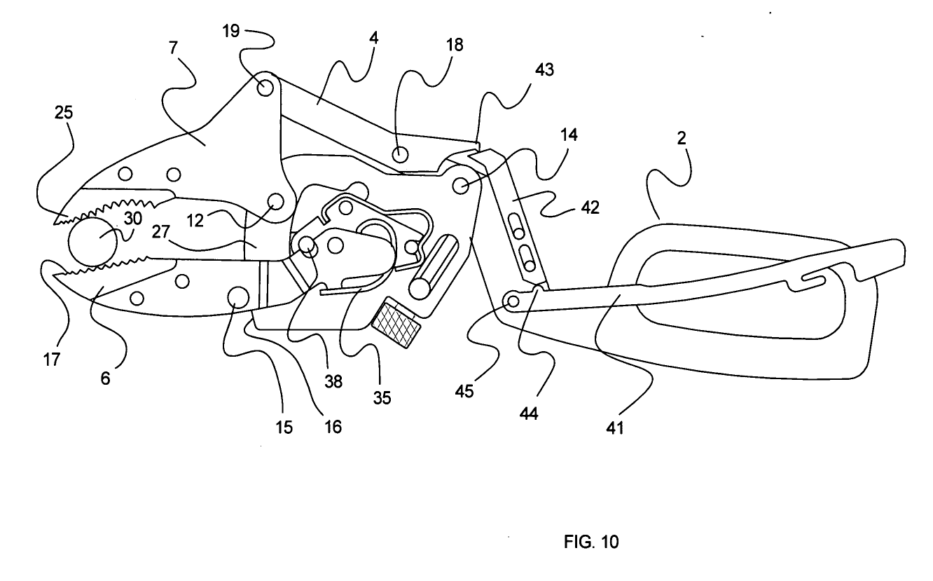

When the user is ready to release the clamped workpiece the user lifts the release lever as shown in FIG. 10. Lifting the release lever 41 effects a rotation of the lever about the release lever pivot 45. The rotation of the release lever causes the release lever cam 44 to contact the release slide 42 and urge it toward the clamp link extension 43. Urging the slide 42 toward the extension 43 has the effect of lifting the clamp link 4 away from the outline profile of the main body 9 and rotating the over-center mechanism back through the hinge colinearity position of pins 19, 18 and 14. Once past the hinge colinearity position, the clamp handle is urged to return to the release position by the clamp handle spring shown in previous figures. This release lever mechanism gives the user a mechanical advantage to easily “unlock” the over-center mechanism and release the workpiece.

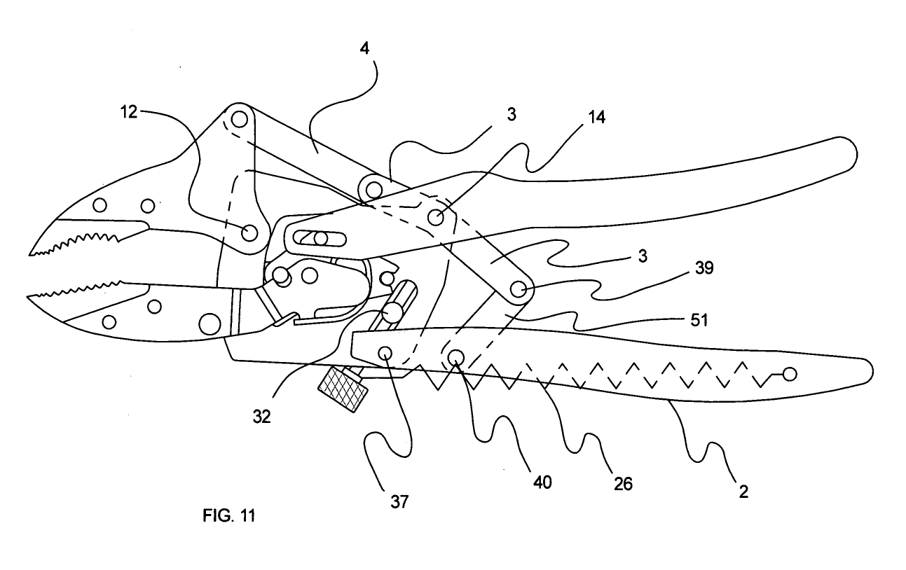

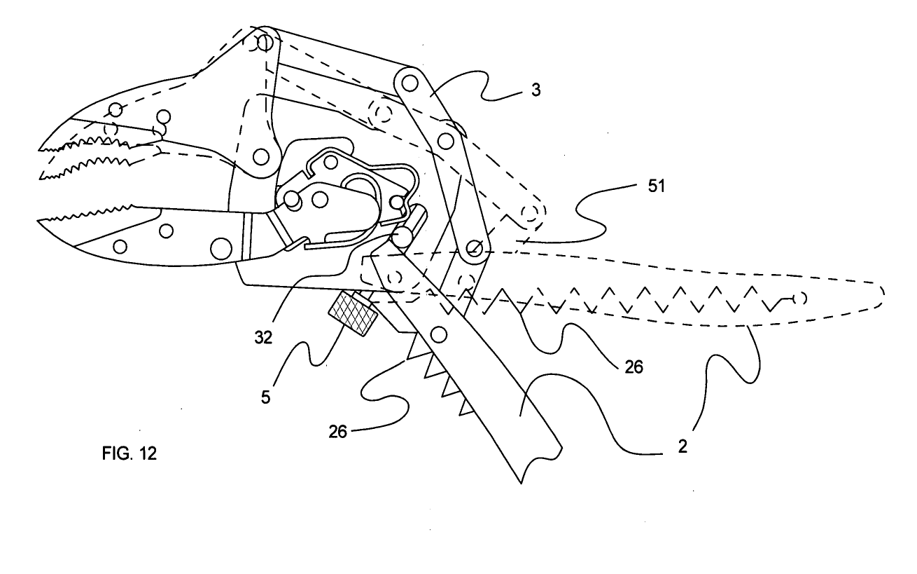

Alternatively, a variation of the over-center linkage such as the design shown in FIGS. 11 and 12 could be used to actuate the clamping jaw mechanism of the tool regardless of the design of the sizing jaw mechanism. This variation of the over-center linkage includes a clamp link 4 and an actuation arm 3 wherein the actuation arm is connected to the clamp handle 2 by a transfer link 51. A first end of the clamp link 4 is hingedly connected to a first end of the actuation arm 3 at the over-center pivot 18. The second end of the clamp link is hingedly connected to the clamp jaw 7 at the jaw drive pivot 19. The actuation arm is hingedly connected to the main body 9 at the first hinge point and also connects to a transfer link 51 at the transfer link pivot 39.

In the preferred embodiment of the tool, the sizing handle is hingedly connected to the main tool body at a first hinge point, the sizing handle pivot 14, and the clamp handle also hinges at the sizing handle pivot. In the alternative embodiment of FIG. 11, the clamp handle hingedly connects to the main tool body at a second hinge point, the clamp handle pivot 37. In the preferred embodiment the first hinge point and second hinge point coincide. In the preferred embodiment and the alternative embodiment the clamping jaw is hingedly connected to the main tool body at a third hinge point, the clamping jaw pivot 12. The actuation arm of the alternative embodiment is pinned or otherwise hingedly connected to the main tool body at the first hinge point. In the preferred embodiment the actuation arm portion of the clamp handle is likewise hingedly connected to the main tool body at the first hinge point. In the alternative embodiment the transfer link 51 is hingedly connected to the actuation arm 3 at the transfer link pivot 39 and is hingedly connected to the clamp handle 2 at the transfer pin 40. A clamp handle return spring 26 still urges the clamp handle to a release position as shown by solid outlines of the components illustrated in FIG. 12. The transfer link 51 connected between the actuation arm 3 and the clamp handle 2 effects rotation of the actuation arm 3 when the user rotates the clamp handle between a release position and a clamp position. A hardstop pin 32 that is threadedly attached to the thumbwheel 5 is still used to control the release position of the clamp handle. The clamp handle rotates from the clamp position until the profile of the handle contacts the hardstop pin to set the release position.

The advantages of the invention are a brake mechanism, an over-center linkage mechanism and a linkage angle setting means combined into one locking pliers tool. The novel integration of a brake mechanism integrated into the first opposable jaw permits automatic jaw gap adjustment for workpieces of varying size. The over-center linkage mechanism integrated into the second opposable jaw enables the operator to apply a repetitive jaw clamping force regardless of the workpiece size. The linkage angle setting means controls the included angle between the over-center linkage members to allow the user to adjust the magnitude of the clamping force that will be applied to the workpiece.

While the embodiments described herein are at present considered to be preferred, it is understood that various modifications and improvements may be made therein without departing from the invention. The scope of the invention is indicated in the appended claims and all changes that come within the meaning and range of equivalency of the claims intended to be embraced therein.

1. An adjustable locking pliers tool comprising:
a main tool body including an inner and outer brake surface;
a sizing handle hingedly connected to the main tool body;
a clamp handle hingedly connected to the main tool body;
a clamp jaw hingedly connected to the main tool body;
a pivot arm operably coupled to the main tool body and having a reaction pad mounted thereonto such that the pivot arm can displace to effect a frictional engagement between said inner brake surface on the main tool body and the reaction pad mounted to the pivot arm;
a sizing jaw hingedly connected to the pivot arm such that the sizing jaw can rotate to effect a frictional engagement between said outer brake surface on the main tool body and a footpad on the sizing jaw;
an over-center linkage operating on said clamp jaw between a release position and a clamp position.

2. The tool of claim 1, further including a pivot arm return spring urging the reaction pad away from said inner brake surface on the main tool body.

3. The tool of claim 1, further including a clamp handle spring urging the over-center linkage toward said release position.

4. The tool of claim 1, further including an adjustment mechanism for adjusting said release position of the over-center linkage.

5. The tool of claim 4, wherein said adjustment mechanism comprises a means for varying a maximum relative rotational position between the main tool body and the clamp handle.

6. The tool of claim 1, further including a sizing handle spring urging the sizing handle toward a largest gap position.

8. The tool of claim 1, wherein said inner brake surface on the main tool body and said reaction pad have a curved conforming geometry.

9. The tool of claim 1, further including a plating of soft material on said inner and outer brake surface.

10. The tool of claim 1, wherein said over-center linkage includes a clamp link and an actuating arm; wherein a first end of the clamp link is hingedly connected to a first end of the actuating arm; wherein another end of the clamp link is hingedly connected to the clamp jaw; and wherein another end of the actuating arm is hingedly connected to the main tool body.

11. The tool of claim 1, wherein said actuating arm is integral with said clamp handle and forms a single component of unitary construction.

12. The tool of claim 1, further including a control spring urging the footpad away from said outer brake surface on the main tool body; a clamp handle spring urging the over-center linkage toward said release position; an adjustment mechanism for adjusting said release position of the over-center linkage; and a sizing handle spring urging the sizing handle toward an open position;
wherein said adjustment mechanism comprises a means for varying a maximum relative rotational position between the main tool body and the clamp handle.

13. An adjustable locking pliers tool comprising:
a main tool body including an inner and outer brake surface;
a sizing handle hingedly connected to the main tool body at a first hinge point;
a clamp handle hingedly connected to the main tool body at a second hinge point;
a clamp jaw hingedly connected to the main tool body at a third hinge point;
a pivot arm operably coupled to the main tool body and having a reaction pad mounted thereonto such that the pivot arm can displace to effect a frictional engagement between said inner brake surface on the main tool body and the reaction pad mounted to the pivot arm;
a sizing jaw hingedly connected to the pivot arm such that the sizing jaw can rotate to effect a frictional engagement between said outer brake surface on the main tool body and a footpad on the sizing jaw;
an over-center linkage operating on said clamp jaw between a release position and a clamp position.

14. The tool of claim 13, wherein said first and second hinge points coincide.

15. The tool of claim 13, wherein said over-center linkage includes a clamp link and an actuating arm; wherein a first end of the clamp link is hingedly connected to a first end of the actuating arm; wherein another end of the clamp link is hingedly connected to the clamp jaw; and wherein rotation of the actuating arm is effected by rotation of the clamp handle via a transfer link connected between the actuating arm and the clamp handle.

18. The tool of claim 13, wherein said inner brake surface in the main tool body and said reaction pad have a curved conforming geometry.

19. The tool of claim 13, further including a control spring urging the footpad away from said outer brake surface on the main tool body.

20. An adjustable locking pliers tool comprising:
a main tool body;
a sizing handle hingedly connected to the main tool body;
a clamp handle hingedly connected to the main tool body;
a clamp jaw hingedly connected to the main tool body;
a pivot arm operably coupled to the main tool body and having a reaction pad mounted thereonto such that the pivot arm can displace to effect a frictional engagement between said inner brake surface on the main tool body and the reaction pad mounted to the pivot arm;
a sizing jaw hingedly connected to the pivot arm such that the sizing jaw can rotate to effect a frictional engagement between said outer brake surface on the main tool body and a footpad on the sizing jaw;
an over-center linkage operating on said clamp jaw between a release position and a clamp position wherein said main tool body, said sizing jaw, said clamping jaw, said pivot arm and said over-center linkage components are of a minimum hardness of 42 on the Rockwell C hardness scale.
